(19) United States
(12) Patent Application Publication
(10) Pub. No.: US 2019/0240756 A1
(43) Pub. Date: Aug. 8, 2019

(54) Electric Soldering Apparatus, in Particular a Soldering Iron

(71) Applicant: ERSA GmbH, Wertheim (DE)

(72) Inventor: Eugen Weissenberger, Eussenheim (DE)

(21) Appl. No.: 16/270,114

(22) Filed: Feb. 7, 2019

(30) Foreign Application Priority Data
Feb. 8, 2018 (DE) 10 2018 102 792.3

(51) Int. Cl. B23K 3/03

(52) U.S. Cl. CPC B23K 3/0369

(57) ABSTRACT

The invention relates to an electric soldering apparatus, in particular a soldering iron, comprising a handle portion, a heating element fastened to the handle portion, a hollow soldering tip into which the heating element engages and fastening means for releasably fastening the soldering tip to the handle portion, wherein the fastening means comprise a permanent magnet that surrounds the heating element, and a ferromagnetic holding part that interacts with the permanent magnet and surrounds the heating element, such that the holding part is non-rotatably arranged on the permanent magnet. The invention also relates to a soldering system comprising a soldering apparatus according to any of the preceding claims, and a removal device for removing the soldering tip from the handle portion.

### DESCRIPTION

The invention relates to an electric soldering apparatus, in particular a soldering iron, comprising a handle portion, a heating element fastened to the handle portion, a hollow soldering tip into which the heating element engages and fastening means for releasably fastening the soldering tip to the handle portion.

Soldering apparatuses of this kind, in particular soldering irons, are known in many different forms. The soldering apparatus can be held and guided at the handle portion in particular by a person. The heating element allows the soldering tip to be heated in order to melt solder. Soldering tips having different geometries can be provided depending on the type of soldering task. Soldering tips can therefore be releasably arranged on the handle element. Screw connections, bayonet connections and latching systems are known.

The problem addressed by the present invention is that of providing a soldering apparatus and a soldering system that provides a temperature-resistant soldering tip that can be easily replaced.

This problem is solved by an electric soldering apparatus having the features of claim 1. The fastening means therefore comprise a permanent magnet that surrounds the heating element, and a ferromagnetic holding part that interacts with the permanent magnet and surrounds the heating element, such that the holding part can be non-rotatably arranged on the permanent magnet. By providing the permanent magnet and the holding part, the soldering tip can thus be securely fastened to the handle portion. The permanent magnet and the ferromagnetic holding part consist of a material that can withstand the soldering temperatures. Since the permanent magnet and the holding part surround the heating element, it can be ensured that the heating element can be guided within the hollow soldering tip as far as the free end thereof in order to heat the soldering tip. The ferromagnetic holding part is designed to be attracted to the permanent magnet. The holding part can likewise be designed as a permanent magnet. The permanent magnet and the holding part are designed such that the components are arranged so as to prevent one another from rotating, as a result of which an undesired rotational movement of the soldering tip about the longitudinal axis can be inhibited when the soldering tip is mounted onto the handle portion.

Due to the ease with which the soldering tip is replaced, the overall handling safety is increased, also because additional tools for replacing the soldering tip are not needed.

Furthermore, the soldering tip can also be easily replaced during soldering, i.e. at an operating temperature. Since high temperatures of up to 600° in parts can be reached on the soldering tip, the following have proven to be suitable alloys for permanent magnets: AlNiCo, SE-Co, Ba-Ferrite, Sr-Ferrite, NdFeB. It should be noted that, during operation, the magnets are operated below their specific Curie temperature, and that their field strength changes only slightly under the influence of temperature.

Advantageously, the permanent magnet and/or the holding part are annular and have an inner diameter that is greater than or equal to the outer diameter of the heating element. In the case of a greater inner diameter, it can be ensured that the heating element can be safely guided through the permanent magnet and/or the holding part, without this resulting in contact. In the case of an inner diameter that is equal to the outer diameter of the heating element, the permanent magnet and/or the holding part can be fastened directly to the heating element.

Furthermore, it is advantageous if the permanent magnet has different polarizations along its circumference such that the holding part can be non-rotatably arranged on the permanent magnet. A rotational movement of the soldering tip can thus be inhibited when the soldering tip is mounted onto the handle portion. The holding part—as already mentioned—can also have a permanent magnetization which is preferably complementary to the magnetization of the permanent magnet. Due to the corresponding polarization of the permanent magnet, rotation of the soldering tip about the longitudinal axis of the soldering iron is not possible, unless a correspondingly high magnetic force is overcome.

In order to prevent the soldering tip rotating relative to the handle portion, it is likewise advantageous if contact portions that interact with one another in an interlocking manner are provided on the permanent magnet and/or on the holding part. The contact portions engage in one another when the soldering tip is mounted onto the handle portion such that the soldering tip cannot be rotated relative to the handle.

It is conceivable in this case for the permanent magnet to comprise a contact portion which is formed by an inner or outer contour of the permanent magnet and for the holding part to comprise a contact portion that is complementary to the contact portion of the permanent magnet and is provided on the outer contour or inner contour of the holding part. The contours are preferably designed such that they can be joined or detached in the longitudinal direction of the soldering tip.

An advantageous design is achieved if the inner contour of the permanent magnet or the holding part is designed as an inner edge and if the outer contour of the holding part or the permanent magnet is designed as an outer edge. The inner edge can be in particular a triangle socket, a square socket or a hexagon socket. The outer edge can be in particular an external triangle, an external square or an external hexagon. A different number of “edges” is likewise conceivable. Advantageously, the soldering tip can then be mounted onto the handle portion in the longitudinal direction such that the respective contours interact with one another in order to prevent rotation.

It is also conceivable for the holding part and the permanent magnet to each have an inner diameter, the inner diameters being the same size at least for the most part. An advantageous design is achieved if the inner diameter of the permanent magnet is 1.5 to 2.5 times or 1.9 to 2.1 times that of the outer diameter of the heating element. This results in favorable spacings such that excessive heating of the permanent magnet is avoided.

The permanent magnet can be arranged on the handle portion or on the soldering tip, the holding part then being provided on the soldering tip or on the handle portion.

It is conceivable for the soldering tip to comprise a union nut having an internal thread, and for the holding part or the permanent magnet to comprise an external thread that is complementary to the internal thread, for fastening said holding part or said permanent magnet to the soldering tip. The union nut can be fixedly or rotatably arranged on the soldering tip.

It is also conceivable for the holding part and/or the permanent magnet to comprise an annular collar that projects radially outward for contacting the soldering tip or the handle portion. Thus, the holding part and/or the permanent magnet can be positioned in a defined manner.

It can also be the case that the permanent magnet or the holding part is fastened to the heating element. Fastening is possible in particular by screwing or by latching. The materials should nevertheless be chosen such that excessive heating of the permanent magnet is inhibited.

The above-mentioned problem is also solved by a soldering system that comprises a soldering apparatus according to the invention, a removal device being provided for removing the soldering tip from the handle portion. The removal device allows the soldering tip to be safely removed during the operation of the soldering apparatus, without additional tools being required.

Further details and designs of the invention can be found in the following description, on the basis of which different embodiments of the invention are explained and described in more detail.

In the drawings:

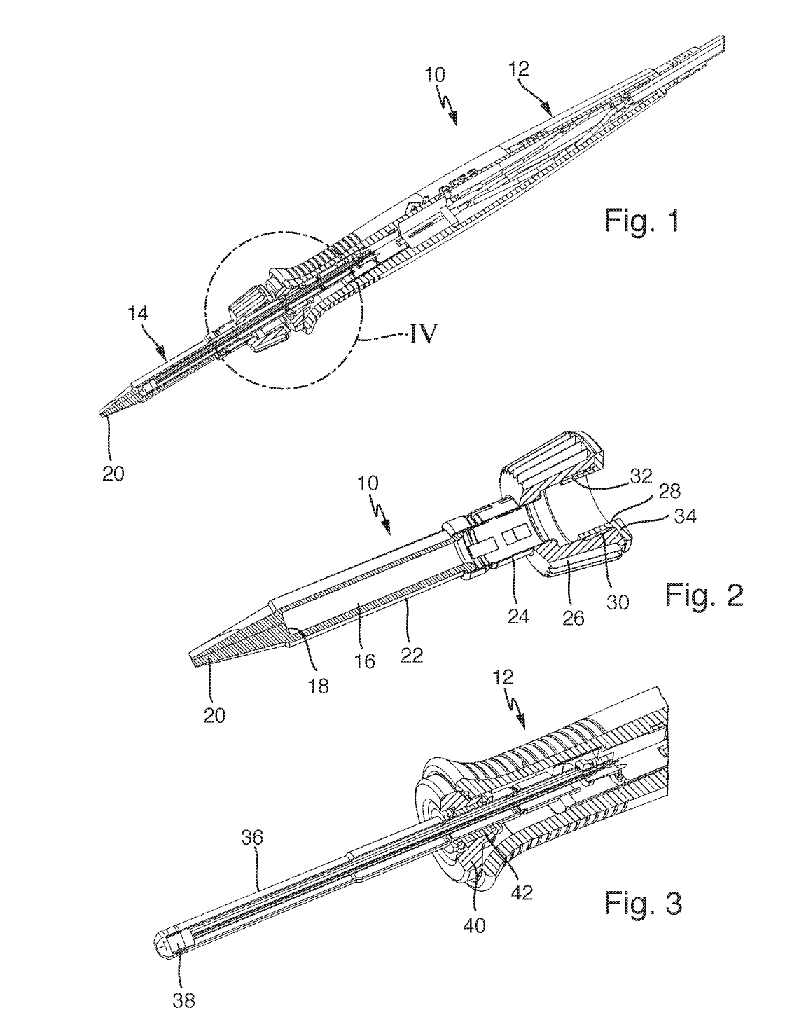

FIG. 1 shows a first soldering apparatus according to the invention;

FIG. 2 shows the soldering tip of the soldering apparatus according to FIG. 1;

FIG. 3 shows the handle portion together with the heating element of the soldering apparatus according to FIG. 1;

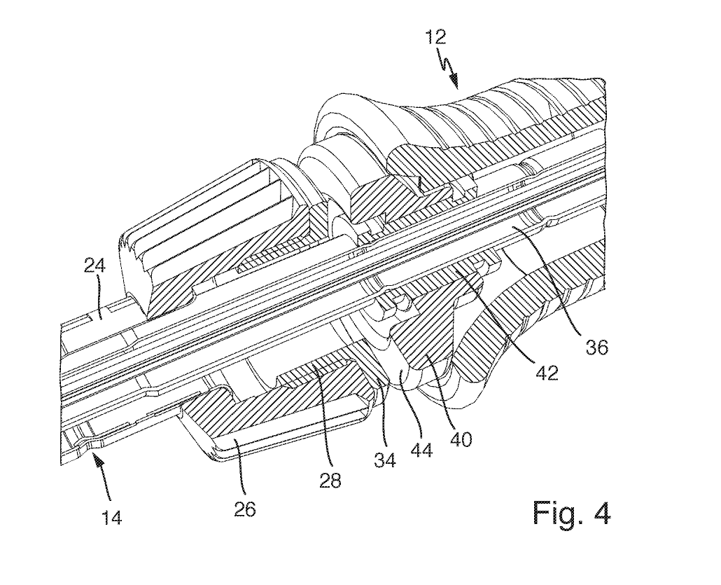

FIG. 4 shows an enlargement of the cutout IV from FIG. 1;

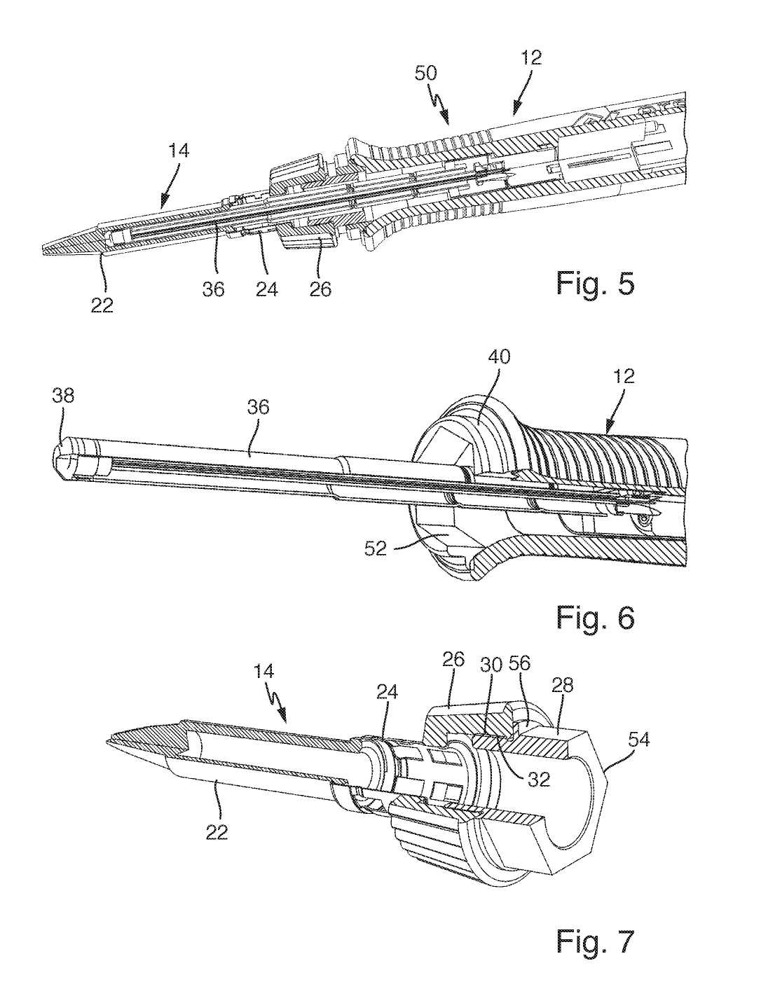

FIG. 5 shows a second soldering apparatus according to the invention;

FIG. 6 shows the soldering tip of the soldering apparatus according to FIG. 5;

FIG. 7 shows the handle portion together with the heating element of the soldering apparatus according to FIG. 5;

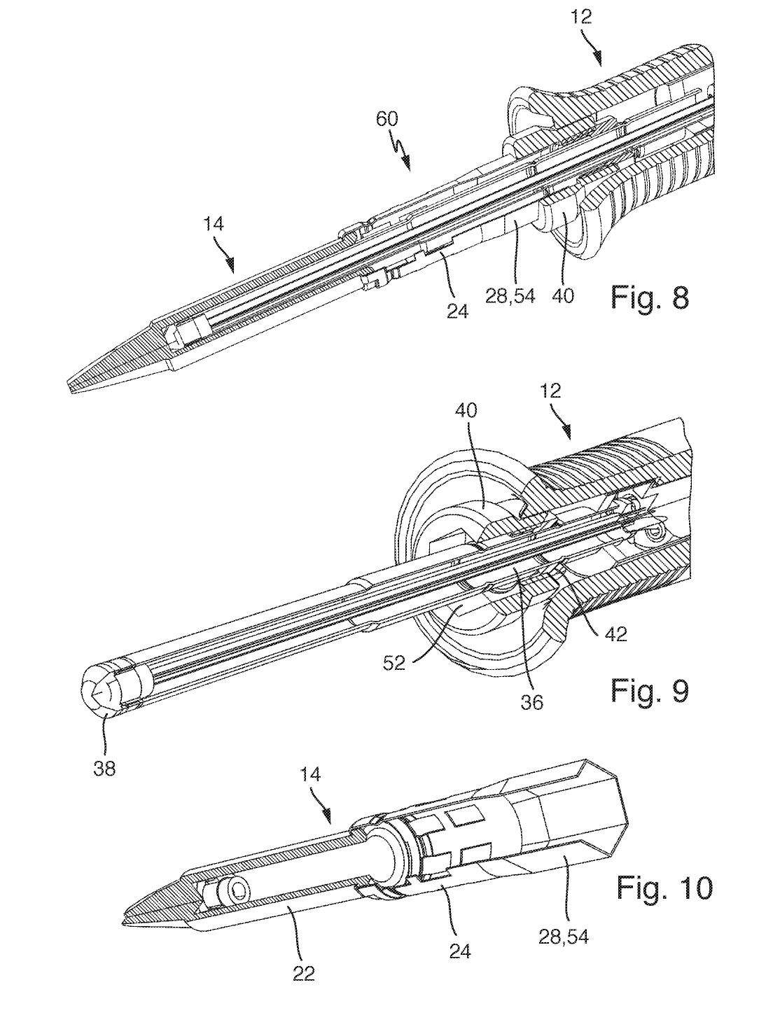

FIG. 8 shows a third soldering apparatus according to the invention;

FIG. 9 shows the soldering tip of the soldering apparatus according to FIG. 8;

FIG. 10 shows the handle portion together with the heating element of the soldering apparatus according to FIG. 8;

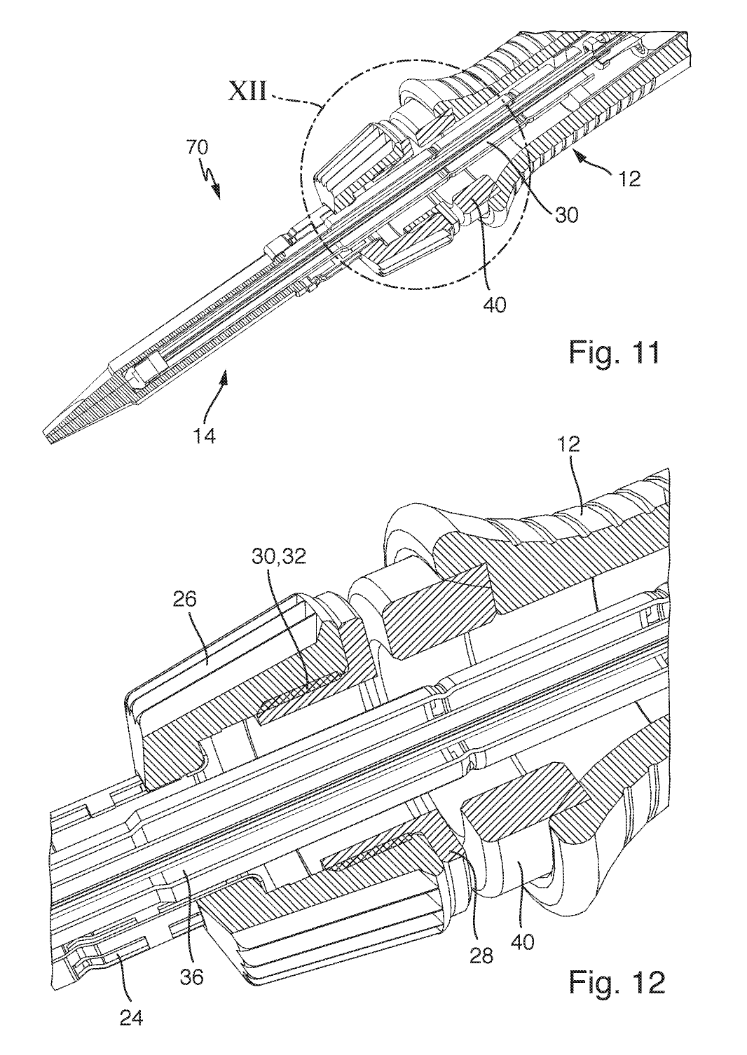

FIG. 11 shows a fourth soldering apparatus according to the invention; and

FIG. 12 shows an enlargement from FIG. 11.

FIG. 1 to 4 show a first embodiment of a soldering iron 10 according to the invention. The soldering iron 10 comprises a handle portion 12 and a soldering tip 14. The soldering tip 14 is releasably arranged on the handle portion 10. As is clear from FIG. 2, which shows the soldering tip 14 as an individual part, the soldering tip 14 comprises a hollow space 16 that has a bottom 18 and extends in the longitudinal direction of the soldering iron 10. The bottom 18 is arranged adjacent to the free end 20 of the soldering tip 14. The soldering tip 14 is formed in its totality of a tip part 22, a sleeve part 24 and a union nut 26 into which a ferromagnetic holding part 28 is screwed. The union nut 26 comprises an internal thread 30 for this purpose. The holding part 28 comprises, on its outer circumference, an external thread 32 that interacts with the internal thread 30. The union nut 26 can, for example, consist of a thermosetting plastic, and the sleeve part 24, which connects the union nut 26 to the tip part 22, can consist in particular of a suitable high-grade steel.

As is clear from the cross section according to FIG. 2, the holding part 28 comprises a circumferential annular collar 34 that projects radially outward.

FIG. 3 shows the handle portion 12, to which a heating element 36 extending in the longitudinal direction is fastened. The heating element 36 comprises a free end 38 that is arranged opposite the bottom 18 of the hollow space 16 when the soldering tip 14 is mounted. An annular permanent magnet 40 is also provided on the handle portion 12. As is clear in particular from the enlargement according to FIG. 4, the permanent magnet 40 is fastened to the heating element 36 by means of a bush 42. The heating element 36 is securely anchored in the handle portion 12.

As is likewise clear from FIG. 4, in which the soldering tip 14 is mounted onto the handle portion 12, the permanent magnet 40 comprises an upper face 44 that extends transversely to the longitudinal extension of the iron 12 and interacts with the annular collar 34 of the holding part 28 such that the soldering tip 14 is held on the handle portion 12 due to magnetic forces. The heating element 36 extends through the permanent magnet 40 and through the holding part 28 that interacts with the permanent magnet 40.

In order to the prevent the soldering tip 14 from rotating relative to the handle portion 12, it is conceivable to polarize the permanent magnet 40 differently along its circumference. A rotational movement of the soldering tip 14 can thus be inhibited when the soldering tip 14 is mounted onto the handle portion 12. Due to the corresponding polarization of the permanent magnet, rotation of the soldering tip about the longitudinal axis of the soldering iron is not possible, unless a correspondingly high magnetic force is overcome.

In order to remove the soldering tip 14, said tip can be easily taken off the soldering iron 10 in the longitudinal direction thereof. Therefore, no additional tools are required to remove the soldering tip 14.

FIG. 4 to 7 show a further soldering iron 50 according to the invention, in which the components corresponding to the soldering iron 10 have corresponding reference numerals. FIG. 6 shows the handle portion 12 of the soldering iron 50, and FIG. 7 shows the soldering tip 14 thereof.

As is clear in particular from FIG. 6, the soldering iron 50 differs from the soldering iron 10 in that the permanent magnet 40 is not arranged on the heating element 34, but directly on the handle portion 12.

The permanent magnet 40 also comprises, on its face facing radially inward, a contact portion 52 that is designed as a hexagon socket. As is clear from FIG. 7, the holding part 28 comprises a contact portion 54 that is designed as a external hexagon provided on the outer contour. When the soldering tip 14 is mounted onto the handle portion, the contact portion 54 of the soldering tip 14 is located in the contact portion 12, as a result of which rotation with the soldering tip 14 relative to the handle portion 12 is prevented. The external hexagon of the holding part 28 thus engages in the hexagon socket of the permanent magnet 40. Due to the magnetic field produced by the permanent magnet 40, the holding part 28 or the entire soldering tip 14 is securely held on the handle portion 12. In order to securely position the holding part 28 on the union nut 26, the holding part 28 comprises an annular collar 56 that projects radially outward.

In order to the prevent the soldering tip 14 from rotating relative to the handle portion 12, it is conceivable—as with the soldering iron 10—to polarize the permanent magnet 40 differently along its circumference in order to inhibit a rotational movement of the soldering tip 14 when the soldering tip 14 is mounted onto the handle portion 12.

FIG. 8 to 10 show a further embodiment of a soldering iron 60 according to the invention. Components corresponding to the soldering iron 10 have corresponding reference numerals.

Corresponding to the soldering iron 10, in the case of the soldering iron 60 the permanent magnet 40 is fastened to the heating element 36 by means of the bush 42. The permanent magnet 40 can in particular be screwed onto the bush 42. The bush 42 can, in turn, be fastened to the heating element 36 by means of a screw connection, a press fit connection or integral bonding. Corresponding to the embodiment of the soldering iron 50, the permanent magnet 40 comprises a contact portion 52 having a hexagon socket on its inner face, which is clear in particular from FIG. 9.

FIG. 10 shows that, in the case of the soldering iron 60, the sleeve part 24 forms the holding part 28 at its end that is remote from the tip part 22. For this purpose, the portion of the sleeve part 24 that is remote from the tip part 22 is designed as a contact portion 54 in the shape of an external hexagon. As is shown in FIG. 8, the holding part 28 or the contact portion 54 dips into the permanent magnet 40 in an interlocking manner when the soldering tip 14 is mounted onto the handle portion 12. Due to the magnetic force, the soldering tip 14 is securely fastened to the handle portion 12.

FIGS. 11 and 12 show a further soldering iron 70 according to the invention, in which the components corresponding to the soldering iron 10 have corresponding reference numerals. In contrast with the soldering iron 10, in the case of the soldering iron 70, the permanent magnet 40 is directly fastened to the handle portion 12 and not to the heating element 36. When the soldering tip 14 is mounted, the permanent magnet 40 interacts with the holding part 28 such that the soldering tip 14 is securely fastened to the handle portion 12.

Even if the permanent magnet 40 is always arranged on the handle portion in the embodiments disclosed, it is conceivable according to the invention to provide the permanent magnet 40 on the soldering tip 14 and to provide the holding part 28 on the handle portion 12. It is also conceivable for the holding part 28 to also consist of a permanently magnetized ferromagnetic material. As is clear from the drawings, the permanent magnet 14 and the holding part 28 surround the heating element 36.

1. Electric soldering apparatus, in particular a soldering iron, comprising a handle portion, a heating element fastened to the handle portion, and a hollow soldering tip into which the heating element engages and fastening means for releasably fastening the soldering tip to the handle portion, wherein the fastening means comprise a permanent magnet that surrounds the heating element, and a ferromagnetic holding part that interacts with the permanent magnet and surrounds the heating element, such that the holding part can be non-rotatably arranged on the permanent magnet.

2. Soldering apparatus according to claim 1, wherein the permanent magnet and/or the holding part are annular and have an inner diameter that is greater than or equal to the outer diameter of the heating element.

3. Soldering apparatus according to claim 1, wherein the permanent magnet has different polarizations along its circumference to ensure mutual rotation-prevention.

4. Soldering apparatus according to claim 1, wherein contact portions that interact with one another in an interlocking manner are provided on the permanent magnet and/or on the holding part to ensure mutual rotation-prevention.

5. Soldering apparatus according to claim 4, wherein the permanent magnet comprises an inner or outer contour as a contact portion and in that the holding part comprises an outer or inner contour complementary thereto as a contact portion.

6. Soldering apparatus according to claim 5, wherein the inner contour of one of the permanent magnet or the holding part is designed as an inner edge and in that the outer contour of the other of the holding part or the permanent magnet is designed as an outer edge.

7. Soldering apparatus according to claim 1, wherein the holding part is annular and has an inner diameter that corresponds to the inner diameter of the permanent magnet.

8. Soldering apparatus according to claim 1, wherein one of the permanent magnet or the holding part is arranged on the handle portion, and the other of the holding part or the permanent magnet is arranged on the soldering tip.

9. Soldering apparatus according to claim 1, wherein a union nut comprising an internal thread is provided on the soldering tip and in that the holding part or the permanent magnet comprises an external thread that is complementary to the internal thread.

10. Soldering apparatus according to claim 1, wherein the holding part and/or the permanent magnet comprise an annular collar that projects radially outward for contacting the soldering tip or the handle portion.

11. Soldering apparatus according to claim 1, wherein the permanent magnet or the holding part is fastened to the heating element.

12. Soldering system comprising a soldering apparatus according to claim 1, and a removal device for removing the soldering tip from the handle portion.
